(19) United States
(12) Patent Application Publication
(10) Pub. No.: US 2026/0261968 A1
(43) Pub. Date: Sep. 3, 2026

(54) METHOD, DEVICE, AND STORAGE MEDIUM FOR DETERMINING USER EQUIPMENT GROUP CORRESPONDING TO WAKE-UP SIGNAL

(71) Applicant: Beijing Xiaomi Mobile Software Co., Ltd., Beijing (CN)

(72) Inventors: Ting FU, Beijing (CN); Qun ZHAO, Beijing (CN)

(73) Assignee: Beijing Xiaomi Mobile Software Co., Ltd., Beijing (CN)

(21) Appl. No.: 18/858,172

(22) PCT Filed: Apr. 21, 2022
(86) PCT No.: PCT/CN2022/088300

§ 371 Date: Oct. 18, 2024

(51) Int. Cl. H04W 52/02; H04W 52/36

(52) U.S. Cl. CPC H04W 52/0229; H04W 52/0219; H04W 52/367

(57) ABSTRACT

A method, device and storage medium for determining a user equipment group corresponding to a wake-up signal in a wireless communication network. The user equipment group is determined by: receiving a wake-up signal from a network device; and on the basis of a feature of the wake-up signal, determining a user equipment group corresponding to the wake-up signal, the feature of the wake-up signal comprises at least one of the following: amplitude, power, duration, and energy. By using the method, a waste of energy consumed by means of a user equipment receiving a false alarm can be avoided.

### CROSS-REFERENCE TO RELATED APPLICATION

The present application is a U.S. National Phase of International Patent Application No. PCT/CN2022/088300 filed on Apr. 21, 2022. The contents of the above-cited application are hereby incorporated by reference for all purposes.

### BACKGROUND OF THE INVENTION

A low power wake up signal (LP WUS) has been introduced by R18. A separate receiver for the LP WUS is used by user equipment. A main transceiver is required for the user equipment to normally process downlink and uplink data. If the user equipment receives the LP WUS indicating wake up, a main receiver will be started for receiving and processing a downlink signal. If the LP WUS is not received or the LP WUS indicates non-wake up, the user equipment will keep the main receiver in a dormant state.

### SUMMARY OF THE INVENTION

In view of that, the disclosure provides a method, apparatus, device, and storage medium for determining user equipment group corresponding to wake up signal.

A first aspect of examples of the disclosure provides a method for determining a user equipment group corresponding to a wake up signal. The method is performed by user equipment. The method includes:
receiving the wake up signal from a network device; and
determining the user equipment group corresponding to the wake up signal on the basis of a feature of the wake up signal.

the feature of the wake up signal includes at least one of amplitude, power, duration, and energy.

In one embodiment, the amplitude is average amplitude or maximum amplitude.

In one embodiment, the power is average power or maximum power.

In one embodiment, the duration is a length of a continuous period in which the amplitude of the wake up signal is greater than a first amplitude threshold.

In one embodiment, the first amplitude threshold is minimum signal amplitude measurable by a receiver, configured to receive the wake up signal, of the user equipment.

In one embodiment, the duration is a length of a continuous period in which instantaneous power of the wake up signal is greater than a first power threshold.

In one embodiment, the first power threshold is minimum signal power measurable by a receiver, configured to receive the wake up signal, of the user equipment.

In one embodiment, the first amplitude threshold or the first power threshold is agreed by a communication protocol or configured by the network device.

In one embodiment, the method further includes:
determining, in response to determining that a time interval between two adjacent wake up signals is shorter than a set length, that the two adjacent wake up signals are one wake up signal, and duration of the one wake up signal is the sum of duration of the two wake up signals and the time interval.

In one embodiment, the energy is the product of average power of the wake up signal and the duration.

In one embodiment, the method further includes:
receiving configuration information from the network device, where the configuration information indicates a plurality of feature values or a plurality of feature value ranges of the feature, and different feature values or different feature value ranges are configured to determine different user equipment groups.

In one embodiment, the method further includes:
obtaining a plurality of feature values or a plurality of feature value ranges of the feature on the basis of a communication protocol, where different feature values or different feature value ranges are configured to determine different user equipment groups.

In one embodiment, the determining the user equipment group corresponding to the wake up signal on the basis of a feature of the wake up signal includes:
determining the user equipment group corresponding to the wake up signal on the basis of the feature of the wake up signal and the plurality of feature values or the plurality of feature value ranges of the feature.

A second aspect of the examples of the disclosure provides a method for determining a user equipment group corresponding to a wake up signal. The method is performed by a network device. The method includes:
determining a feature of the wake up signal on the basis of the user equipment group to which user equipment belongs; and sending the wake up signal having the feature to the user equipment.

The feature of the wake up signal includes at least one of amplitude, power, duration, and energy.

In one embodiment, the amplitude is average amplitude or maximum amplitude.

In one embodiment, the power is average power or maximum power.

In one embodiment, the duration is a length of a continuous period in which the amplitude of the wake up signal is greater than a first amplitude threshold.

In one embodiment, the first amplitude threshold is minimum signal amplitude measurable by a receiver, configured to receive the wake up signal, of the user equipment.

In one embodiment, the duration is a length of a continuous period in which instantaneous power of the wake up signal is greater than a first power threshold.

In one embodiment, the first power threshold is minimum signal power measurable by a receiver, configured to receive the wake up signal, of the user equipment.

In one embodiment, the first power threshold or the first amplitude threshold is agreed by a communication protocol or configured by the network device.

In one embodiment, the energy is the product of average power of the wake up signal and the duration.

In one embodiment, the method further includes:
sending configuration information to the user equipment, where the configuration information indicates a plurality of feature values or a plurality of feature value ranges of the feature, and different feature values or different feature value ranges are configured to determine different user equipment groups.

In one embodiment, the sending the wake up signal to the user equipment includes:
sending two adjacent wake up signals to the user equipment, where a time interval between the two adjacent wake up signals is longer than or equal to a set length.

A third aspect of the examples of the disclosure provides a mobile terminal. The mobile terminal includes:
a processor; and
a memory configured to store an instruction executable by the processor.
the processor is configured to execute the executable instruction in the memory, so as to implement steps of the above method for determining a user equipment group corresponding to a wake up signal.

A fourth aspect of the examples of the disclosure provides a network side device. The network side device includes:
a processor; and
a memory configured to store an instruction executable by the processor.
the processor is configured to execute the executable instruction in the memory, so as to implement steps of the above method for determining a user equipment group corresponding to a wake up signal.

A fifth aspect of the examples of the disclosure provides a non-transitory computer-readable storage medium, which stores an executable instruction. When the executable instruction is performed by a processor, steps of the above method for determining a user equipment group corresponding to a wake up signal are implemented.

It is to be understood that the above general description and the following detailed description are merely illustrative and explanatory, instead of limiting the disclosure.

### BRIEF DESCRIPTION OF DRAWINGS

The accompanying drawings described here serve to provide further understanding of examples of the disclosure and form part of the disclosure. Examples in the examples of the disclosure and their description serve to explain the examples of the disclosure and are not to be construed as unduly limiting the examples of the disclosure. In the drawings:

Accompanying drawings here are incorporated in the description as a constituent part of the description, illustrate examples conforming to examples of the disclosure, and serve to describe principles of the examples of the disclosure together with the description.

FIG. 1 is a flow diagram of a method for determining a user equipment group corresponding to a wake up signal according to one example;

FIG. 2 is a flow diagram of a method for determining a user equipment group corresponding to a wake up signal according to one example;

FIG. 3 is a flow diagram of a method for determining a user equipment group corresponding to a wake up signal according to one example;

FIG. 4 is a flow diagram of a method for determining a user equipment group corresponding to a wake up signal according to one example;

FIG. 5 is a flow diagram of a method for determining a user equipment group corresponding to a wake up signal according to one example;

FIG. 6 is a flow diagram of a method for determining a user equipment group corresponding to a wake up signal according to one example;

FIG. 7 is a flow diagram of a method for determining a user equipment group corresponding to a wake up signal according to one example;

FIG. 8 is a block diagram of an apparatus for determining a user equipment group corresponding to a wake up signal according to one example;

FIG. 9 is a block diagram of an apparatus for determining a user equipment group corresponding to a wake up signal according to one example;

FIG. 10 is a structural diagram of an apparatus for determining a user equipment group corresponding to a wake up signal according to one example; and

FIG. 11 is a structural diagram of an apparatus for determining a user equipment group corresponding to a wake up signal according to one example.

### DETAILED DESCRIPTION OF THE INVENTION

Examples of the disclosure are further described with reference to accompanying drawings and specific embodiments.

Examples will be described in detail here and illustratively shown in the accompanying drawings. When the following descriptions involve the accompanying drawings, unless otherwise specified, a same number in different accompanying drawings denotes the same or similar elements. The embodiments described in the following examples do not denote all embodiments consistent with the disclosure examples. On the contrary, the embodiments are merely instances of an apparatus and a method consistent with some aspects of the disclosure as detailed in the appended claims.

It is to be noted that one example of the disclosure can include a plurality of steps. The steps are numbered for convenience of description. However, the numbers do not limit an execution time slot and an execution order between the steps. The steps can be implemented in any order, which is not limited by the example of the disclosure.

In the description of the disclosure, the words “first”, “second”, “third”, etc. are used merely to distinguish between descriptions and cannot be construed as indicating or implying relative importance or an order. The word “plurality” means two or more.

When describing an association relation of associated objects, “and/or” means that there may be three relations, for instance, A and/or B, which may mean that A exists alone, both A and B exist, or B exists alone.

The disclosure relates to the technical field of wireless communication, and particularly relates to a method, apparatus, device, and storage medium for determining user equipment group corresponding.

It is to be noted that if a wake up signal (WUS) has no grouping function or has not fine enough grouping granularity, one WUS is caused to wake up a large amount of user equipment, and most of the user equipment receives false alarm. Energy of the user equipment that receives the false alarm may be wasted.

In view of this, the technical solution provided by the examples of the disclosure on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive a paging message or other downlink information, such as downlink data and downlink control information, is determined on the basis of an indication of the wake up signal. Through the method, a waste of energy of the user equipment caused by false alarm can be prevented.

An example of the disclosure provides a method for determining a user equipment group corresponding to a wake up signal. The method is performed by user equipment. FIG. 1 is a flow diagram of a method for determining a user equipment group corresponding to a wake up signal according to one example. As shown in FIG. 1, the method includes:
Step 101, the wake up signal from a network device is received.
Step 102, the user equipment group corresponding to the wake up signal is determined on the basis of a feature of the wake up signal.

The feature of the wake up signal includes at least one of amplitude, power, duration, and energy.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy.

For instance, the wake up signal transmitted by the network device is received by the user equipment, the power of the received wake up signal is detected, and the user equipment group corresponding to the wake up signal is determined on the basis of the power of the wake up signal.

For instance, the wake up signal transmitted by the network device is received by the user equipment, the power and the duration of the received wake up signal are detected, and the user equipment group corresponding to the wake up signal is determined on the basis of the power and the duration of the wake up signal.

The wake up signal may be detected by the user equipment in modes of the prior art, and through non-coherent detection including envelope detection and energy detection, for instance. The feature of the wake up signal is obtained by the user equipment in the detection modes, and for instance, through detection of the amplitude, the power and the duration of the wake up signal. Alternatively, other features are obtained by further processing some features of the wake up signal detected, the power and the duration of the wake up signal are detected, and the power and the duration are multiplied, such that the energy of the wake up signal is obtained.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by user equipment. the method includes:
the wake up signal from a network device is received; and
the user equipment group corresponding to the wake up signal is determined on the basis of a feature of the wake up signal.

The feature of the wake up signal includes at least one of amplitude, power, duration, and energy. The amplitude is average amplitude or maximum amplitude.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The amplitude is the average amplitude.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The amplitude is the maximum amplitude.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by user equipment. the method includes:
the wake up signal from a network device is received; and
the user equipment group corresponding to the wake up signal is determined on the basis of a feature of the wake up signal.

The feature of the wake up signal includes at least one of amplitude, power, duration, and energy. The power is average power or maximum power.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The power is the average power.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The power is the maximum power.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by user equipment. the method includes:
the wake up signal from a network device is received; and
the user equipment group corresponding to the wake up signal is determined on the basis of a feature of the wake up signal.

The feature of the wake up signal includes at least one of amplitude, power, duration, and energy. The duration is a length of a continuous period in which the amplitude of the wake up signal is greater than a first amplitude threshold.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The duration is a length of a continuous period in which the amplitude of the wake up signal is greater than a first amplitude threshold.

In one embodiment, the first amplitude threshold is minimum signal amplitude measurable by a receiver, configured to receive the wake up signal, of the user equipment. That is, the first amplitude threshold is determined by the user equipment on the basis of capability of the receiver of the user equipment.

In one embodiment, the first amplitude threshold is agreed by a communication protocol. That is, the first amplitude threshold is determined by the user equipment on the basis of an agreement of the communication protocol.

In one embodiment, the first amplitude threshold is configured by the network device. That is, configuration information from the network device is received by the user equipment, and the first amplitude threshold is determined on the basis of the configuration information.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by user equipment. the method includes:
the wake up signal from a network device is received; and
the user equipment group corresponding to the wake up signal is determined on the basis of a feature of the wake up signal.

The feature of the wake up signal includes at least one of amplitude, power, duration, and energy. The duration is a length of a continuous period in which instantaneous power of the wake up signal is greater than a first power threshold.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The duration is a length of a continuous period in which instantaneous power of the wake up signal is greater than a first power threshold.

In one embodiment, the first power threshold is minimum signal power measurable by a receiver, configured to receive the wake up signal, of the user equipment. That is, the first power threshold is determined by the user equipment on the basis of capability of the receiver of the user equipment.

In one embodiment, the first power threshold is agreed by a communication protocol. That is, the first power threshold is determined by the user equipment on the basis of an agreement of the communication protocol.

In one embodiment, the first power threshold is configured by the network device. That is, configuration information from the network device is received by the user equipment, and the first power threshold is determined on the basis of the configuration information.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

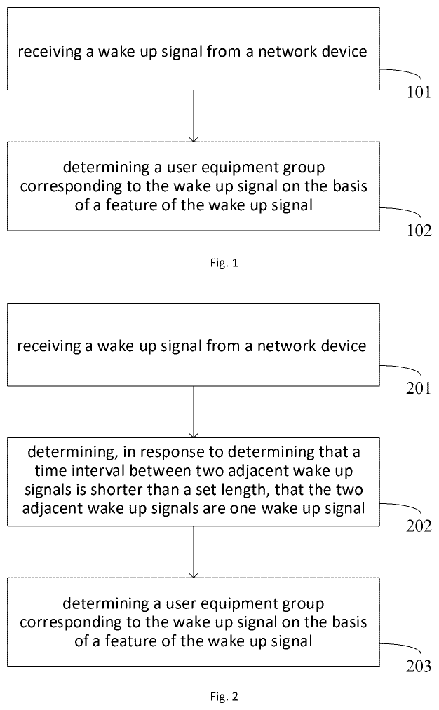

An example of the disclosure provides a method for determining a user equipment group corresponding to a wake up signal. The method is performed by user equipment. FIG. 2 is a flow diagram of a method for determining a user equipment group corresponding to a wake up signal according to one example. As shown in FIG. 2, the method includes:
Step 201, the wake up signal from a network device is received.
Step 202, in response to determining that a time interval between two adjacent wake up signals is shorter than a set length, it is determined that the two adjacent wake up signals are one wake up signal, and duration of the one wake up signal is the sum of duration of the two wake up signals and the time interval.
Step 203, the user equipment group corresponding to the wake up signal is determined on the basis of a feature of the wake up signal.

The feature of the wake up signal includes at least one of amplitude, power, duration, and energy.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the time interval between the two adjacent wake up signals received by the user equipment is shorter than the set length, it is determined that the two adjacent wake up signals are the one wake up signal. In this case, the duration of the one wake up signal is the duration of the two wake up signals plus the time interval between the two wake up signals. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The energy is the product of average power of the wake up signal and the duration.

It is to be noted that two wake up signals received by the user equipment may correspond to one wake up signal transmitted by the network device due to influence of deep channel fading in a short time. That is, the one wake up signal transmitted by the network device is influenced by channel transmission, and the wake up signal received by the user equipment may be interrupted. However, the interrupted wake up signal is still considered as one wake up signal.

For instance, the set length is 8 microseconds, or 16 microseconds.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by user equipment. the method includes:
the wake up signal from a network device is received; and
the user equipment group corresponding to the wake up signal is determined on the basis of a feature of the wake up signal.

The feature of the wake up signal includes at least one of amplitude, power, duration, and energy. The energy is the product of average power of the wake up signal and the duration.

In one embodiment, the wake up signal transmitted by the network device is received by user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy. The energy is the product of average power of the wake up signal and the duration.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

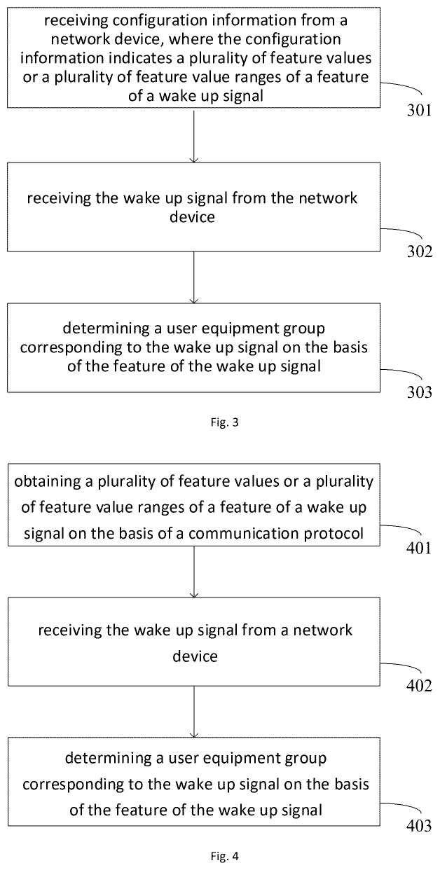

An example of the disclosure provides a method for determining a user equipment group corresponding to a wake up signal. The method is performed by user equipment. FIG. 3 is a flow diagram of a method for determining a user equipment group corresponding to a wake up signal according to one example. As shown in FIG. 3, the method includes:
Step 301, configuration information from a network device is received, where the configuration information indicates a plurality of feature values or a plurality of feature value ranges of a feature of the wake up signal.
Step 302, the wake up signal from the network device is received.
Step 303, the user equipment group corresponding to the wake up signal is determined on the basis of the feature of the wake up signal.

The feature of the wake up signal includes at least one of amplitude, power, duration, and energy. Different feature values or different feature value ranges are configured to determine different user equipment groups.

In one embodiment, the configuration information from the network device is received by the user equipment. The configuration information indicates the plurality of feature values of the feature of the wake up signal. The plurality of feature values correspond to different user equipment groups. The wake up signal transmitted by the network device is received by the user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy.

In one embodiment, the configuration information from the network device is received by the user equipment. The configuration information indicates the plurality of feature values of the feature of the wake up signal. The plurality of feature values correspond to different user equipment groups. The wake up signal transmitted by the network device is received by the user equipment, the feature of the received wake up signal is detected, and the user equipment group corresponding to the wake up signal is determined on the basis of the feature of the wake up signal and the plurality of feature values of the feature. For instance, in response to determining that the power of the detected wake up signal is equal to P1 of the plurality of feature values of the power or closest to P1 of the plurality of feature values of the power, it is determined that the wake up signal corresponds to a user equipment group corresponding to the feature value P1. In addition, in response to determining that the user equipment belongs to the user equipment group corresponding to the wake up signal, whether to receive the paging message is determined on the basis of the indication of the wake up signal. The feature of the wake up signal includes at least one of amplitude, power, duration, and energy.

In one embodiment, the configuration information from the network device is received by the user equipment. The configuration information indicates the plurality of feature value ranges of the feature of the wake up signal. The plurality of feature value ranges correspond to different user equipment groups. The wake up signal transmitted by the network device is received by the user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy.

In one embodiment, the configuration information from the network device is received by the user equipment. The configuration information indicates the plurality of feature value ranges of the feature of the wake up signal. The plurality of feature value ranges correspond to different user equipment groups. The wake up signal transmitted by the network device is received by the user equipment, the feature of the received wake up signal is detected, and the user equipment group corresponding to the wake up signal is determined on the basis of the feature of the wake up signal and the plurality of feature value ranges of the feature. For instance, in response to determining that the power of the detected wake up signal falls within one feature value range of the power, it is determined that the wake up signal corresponds to a user equipment group corresponding to the feature value range. In addition, in response to determining that the user equipment belongs to the user equipment group corresponding to the wake up signal, whether to receive the paging message is determined on the basis of the indication of the wake up signal. The feature of the wake up signal includes at least one of amplitude, power, duration, and energy.

In one embodiment, the configuration information from the network device is received by the user equipment, and the configuration information indicates three feature values P1, P2, P3 of power, which correspond to four feature value ranges of the power: (−∞, P1], (P1, P2], (P2, P3], (P3, +∞). The four feature value ranges of the power correspond to user equipment group 1, user equipment group 2, user equipment group 3, and user equipment group 4 sequentially. If average power of the wake up signal detected by the user equipment is within the range of (−∞, P1], the user equipment determines that the wake up signal corresponds to the user equipment group 1. In response to determining that average power of the wake up signal detected by the user equipment is within the range of (P1, P2], the user equipment determines that the wake up signal corresponds to the user equipment group 2. In response to determining that average power of the wake up signal detected by the user equipment is within the range of (P2, P3], the user equipment determines that the wake up signal corresponds to the user equipment group 3. If average power of the wake up signal detected by the user equipment is within the range of (P3, +∞), the user equipment determines that the wake up signal corresponds to the user equipment group 4.

In one embodiment, the configuration information from the network device is received by the user equipment. The configuration information indicates three feature values P1, P2, P3 of power, which correspond to four feature value ranges of the power: (−∞, P1], (P1, P2], (P2, P3], (P3, +∞), and indicates three feature values T1, T2, and T3 of the duration, which correspond to four feature value ranges of the duration: [0, T1], (T1, T2], (T2, T3], and (T3, +∞). Combinations of the four feature value ranges of the power and the four feature value ranges of the duration correspond to 16 user equipment groups respectively. If the average power of the wake up signal detected by the user equipment is within the range of (−∞, P1] and the duration of the wake up signal is within the range of [0, T1], the user equipment determines that the wake up signal corresponds to the user equipment (UE) group 1. If the average power of the wake up signal detected by the user equipment is within the range of (−∞, P1] and the duration of the wake up signal is within the range of (T1, T2], the user equipment determines that the wake up signal corresponds to the UE group 2. If the average power of the wake up signal detected by the user equipment is within the range of (−∞, P1] and the duration of the wake up signal is within the range of (T2, T3], the user equipment determines that the wake up signal corresponds to the UE group 3. If the average power of the wake up signal detected by the user equipment is within the range of (−∞, P1] and the duration of the wake up signal is within the range of (T3, +∞), the user equipment determines that the wake up signal corresponds to the UE group 4. If the average power of the wake up signal detected by the user equipment is within the range of (P1, P2] and the duration of the wake up signal is within the range of [0, T1], the user equipment determines that the wake up signal corresponds to the UE group 5. If the average power of the wake up signal detected by the user equipment is within the range of (P1, P2] and the duration of the wake up signal is within the range of (T1, T2], the user equipment determines that the wake up signal corresponds to the UE group 6. The rest may be done in the same manner.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

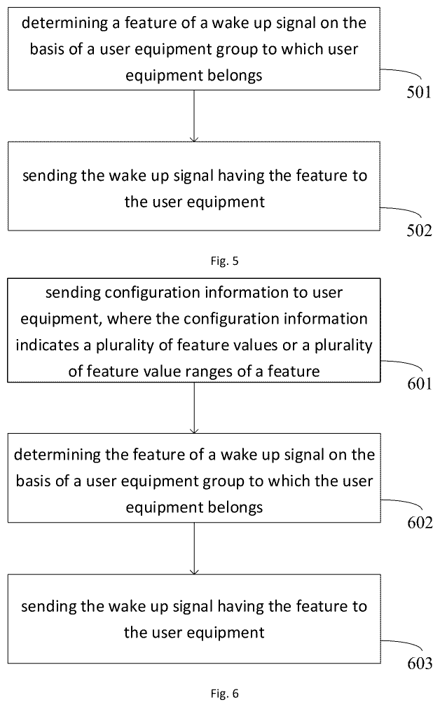

An example of the disclosure provides a method for determining a user equipment group corresponding to a wake up signal. The method is performed by user equipment. FIG. 4 is a flow diagram of a method for determining a user equipment group corresponding to a wake up signal according to one example. As shown in FIG. 4, the method includes:
Step 401, a plurality of feature values or a plurality of feature value ranges of a feature of the wake up signal are obtained on the basis of a communication protocol.
Step 402, the wake up signal from a network device is received.
Step 403, the user equipment group corresponding to the wake up signal is determined on the basis of the feature of the wake up signal.

The feature of the wake up signal includes at least one of amplitude, power, duration, and energy. Different feature values or different feature value ranges are configured to determine different user equipment groups.

In one embodiment, the plurality of feature values of the feature of the wake up signal are obtained by the user equipment on the basis of the communication protocol. The plurality of feature values correspond to different user equipment groups. The wake up signal transmitted by the network device is received by the user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy.

In one embodiment, the plurality of feature values of the feature of the wake up signal are obtained on the basis of the communication protocol. The plurality of feature values correspond to different user equipment groups. The wake up signal transmitted by the network device is received by the user equipment, the feature of the received wake up signal is detected, and the user equipment group corresponding to the wake up signal is determined on the basis of the feature of the wake up signal and the plurality of feature values of the feature. For instance, in response to determining that the power of the detected wake up signal is equal to P1 of the plurality of feature values of the power or closest to P1 of the plurality of feature values of the power, it is determined that the wake up signal corresponds to a user equipment group corresponding to the feature value P1. In addition, in response to determining that the user equipment belongs to the user equipment group corresponding to the wake up signal, whether to receive the paging message is determined on the basis of the indication of the wake up signal. The feature of the wake up signal includes at least one of amplitude, power, duration, and energy.

In one embodiment, the plurality of feature value ranges of the feature of the wake up signal are obtained on the basis of the communication protocol. The plurality of feature value ranges correspond to different user equipment groups. The wake up signal transmitted by the network device is received by the user equipment, the feature of the received wake up signal is detected, and the user equipment group corresponding to the wake up signal is determined on the basis of the feature of the wake up signal. In response to determining that the user equipment belongs to the user equipment group corresponding to the wake up signal, whether to receive a paging message is determined on the basis of an indication of the wake up signal. The feature of the wake up signal includes at least one of amplitude, power, duration, and energy.

In one embodiment, the plurality of feature value ranges of the feature of the wake up signal are obtained on the basis of the communication protocol. The plurality of feature value ranges correspond to different user equipment groups. The wake up signal transmitted by the network device is received by the user equipment, the feature of the received wake up signal is detected, and the user equipment group corresponding to the wake up signal is determined on the basis of the feature of the wake up signal and the plurality of feature value ranges of the feature. For instance, in response to determining that the power of the detected wake up signal falls within one feature value range of the power, it is determined that the wake up signal corresponds to a user equipment group corresponding to the feature value range. In addition, in response to determining that the user equipment belongs to the user equipment group corresponding to the wake up signal, whether to receive the paging message is determined on the basis of the indication of the wake up signal. The feature of the wake up signal includes at least one of amplitude, power, duration, and energy.

In the embodiment, on the basis of the feature of the received wake up signal, the user equipment group corresponding to the wake up signal is determined by the user equipment, and further whether the user equipment group is a user equipment group to which the user equipment belongs is determined. In response to determining that the user equipment group is the user equipment group to which the user equipment belongs, whether to receive the paging message or other downlink information, such as downlink data and downlink control information, is determined on the basis of the indication of the wake up signal. Through the method, a waste of energy of the user equipment caused by false alarm can be prevented.

An example of the disclosure provides a method for determining a user equipment group corresponding to a wake up signal. The method is performed by a network device. FIG. 5 is a flow diagram of a method for determining a user equipment group corresponding to a wake up signal according to one example. As shown in FIG. 5, the method includes:
Step 501, a feature of the wake up signal is determined on the basis of the user equipment group to which user equipment belongs.
Step 502, the wake up signal having the feature is transmitted to the user equipment.

The feature of the wake up signal includes at least one of amplitude, power, duration, and energy.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. the method includes:
a feature of the wake up signal is determined on the basis of the user equipment group to which user equipment belongs; and
the wake up signal having the feature is transmitted to the user equipment.

The feature of the wake up signal includes at least one of amplitude, power, duration, and energy. The amplitude is average amplitude or maximum amplitude.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The amplitude is the average amplitude.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The amplitude is the maximum amplitude.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. the method includes:
a feature of the wake up signal is determined on the basis of the user equipment group to which user equipment belongs; and
the wake up signal having the feature is transmitted to the user equipment.

The feature of the wake up signal includes at least one of amplitude, power, duration, and energy. The power is average power or maximum power.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The power is the average power.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The power is the maximum power.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. the method includes:
a feature of the wake up signal is determined on the basis of the user equipment group to which user equipment belongs; and
the wake up signal having the feature is transmitted to the user equipment.

The feature of the wake up signal includes at least one of amplitude, power, duration, and energy. The duration is a length of a continuous period in which the amplitude of the wake up signal is greater than a first amplitude threshold.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The duration is a length of a continuous period in which the amplitude of the wake up signal is greater than a first amplitude threshold.

In one embodiment, the first amplitude threshold is minimum signal amplitude measurable by a receiver, configured to receive the wake up signal, of the user equipment. That is, the first amplitude threshold is determined by the network device on the basis of capability of the receiver of the user equipment.

In one embodiment, the first amplitude threshold is agreed by a communication protocol. That is, the first amplitude threshold is determined by the network device on the basis of an agreement of the communication protocol.

In one embodiment, the first amplitude threshold is configured by the network device. That is, the first amplitude threshold is configured by the network device.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. the method includes:
a feature of the wake up signal is determined on the basis of the user equipment group to which user equipment belongs; and
the wake up signal having the feature is transmitted to the user equipment.

The feature of the wake up signal includes at least one of amplitude, power, duration, and energy. The duration is a length of a continuous period in which instantaneous power of the wake up signal is greater than a first power threshold.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The duration is a length of a continuous period in which instantaneous power of the wake up signal is greater than a first power threshold.

In one embodiment, the first power threshold is minimum signal power measurable by a receiver, configured to receive the wake up signal, of the user equipment. That is, the first power threshold is determined by the network device on the basis of capability of the receiver of the user equipment.

In one embodiment, the first power threshold is agreed by a communication protocol. That is, the first power threshold is determined by the network device on the basis of an agreement of the communication protocol.

In one embodiment, the first power threshold is configured by the network device. That is, the first power threshold is configured by the network device.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. the method includes:
a feature of the wake up signal is determined on the basis of the user equipment group to which user equipment belongs; and
the wake up signal having the feature is transmitted to the user equipment.

The feature of the wake up signal includes at least one of amplitude, power, duration, and energy. The energy is the product of average power of the wake up signal and the duration.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy. The energy is the product of average power of the wake up signal and the duration.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. FIG. 6 is a flow diagram of a method for determining a user equipment group corresponding to a wake up signal according to one example. As shown in FIG. 6, the method includes:
Step 601, configuration information is transmitted to user equipment, where the configuration information indicates a plurality of feature values or a plurality of feature value ranges of a feature.
Step 602, the feature of the wake up signal is determined on the basis of the user equipment group to which the user equipment belongs.
Step 603, the wake up signal having the feature is transmitted to the user equipment.

The feature of the wake up signal includes at least one of amplitude, power, duration, and energy. Different feature values or different feature value ranges are configured to determine different user equipment groups.

In one embodiment, the configuration information is transmitted to the user equipment by the network device. The configuration information indicates the plurality of feature values of the feature of the wake up signal. The plurality of feature values correspond to different user equipment groups. The feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy.

In one embodiment, the configuration information is transmitted to the user equipment by the network device. The configuration information indicates the plurality of feature value ranges of the feature of the wake up signal. The plurality of feature value ranges correspond to different user equipment groups. The feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. The feature of the wake up signal includes at least one of amplitude, power, duration, and energy.

In one embodiment, the configuration information is transmitted to the user equipment by the network device, and the configuration information indicates three feature values P1, P2, P3 of power, which correspond to four feature value ranges of the power: (-−∞, P1], (P1, P2], (P2, P3], (P3, +∞). The four feature value ranges of the power correspond to user equipment group 1, user equipment group 2, user equipment group 3, and user equipment group 4 sequentially. For instance, in response to determining that the user equipment group to which the user equipment to receive the wake up signal belongs is the user equipment group 1 by the network device, and determining that the average power of the wake up signal has to be within the range of (−∞, P1], a power value within the range of (−∞, P1] is determined as the average power of the wake up signal, and the wake up signal is transmitted at the average power.

In one embodiment, the configuration information from the network device is received by the user equipment. The configuration information indicates three feature values P1, P2, P3 of power, which correspond to four feature value ranges of the power: (−∞, P1], (P1, P2], (P2, P3], (P3, +∞), and indicates three feature values T1, T2, and T3 of the duration, which correspond to four feature value ranges of the duration: [0, T1], (T1, T2], (T2, T3], and (T3, +∞). Combinations of the four feature value ranges of the power and the four feature value ranges of the duration correspond to 16 user equipment groups respectively. For instance, in response to determining that the user equipment group to which the user equipment to receive the wake up signal belongs is the user equipment group 1 by the network device, determining that the average power of the wake up signal has to be within the range of (−∞, P1], and determining that the duration of the wake up signal is within the range of [0, T1], a power value within the range of (−∞, P1] is determined as the average power of the wake up signal, duration within the range of [0, T1] is determined as the duration of the wake up signal, and the wake up signal is transmitted at the average power and the duration.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides a method for determining a user equipment group corresponding to a wake up signal. The method is performed by a network device. FIG. 7 is a flow diagram of a method for determining a user equipment group corresponding to a wake up signal according to one example. As shown in FIG. 7, the method includes:
Step 701, a feature of the wake up signal is determined on the basis of the user equipment group to which user equipment belongs.
Step 702, the wake up signal having the feature is transmitted to the user equipment, in response to sending two adjacent wake up signals to the user equipment, a time interval between the two adjacent wake up signals is longer than or equal to a set length.

The feature of the wake up signal includes at least one of amplitude, power, duration, and energy.

In one embodiment, the feature of the wake up signal is determined by the network device on the basis of the user equipment group to which the user equipment to receive the wake up signal belongs. The user equipment group corresponds to one feature value or one feature value range of the feature of the wake up signal, such that the determined feature of the wake up signal has the feature value or is within the feature value range. The wake up signal having the determined feature is transmitted to the user equipment by the network device. After the wake up signal is transmitted by the network device, a next wake up signal is transmitted at a time interval longer than the set length. The feature of the wake up signal includes at least one of amplitude, power, duration, and energy.

It is to be noted that the one wake up signal transmitted by the network device is influenced by channel transmission due to influence of deep channel fading in a short time, and the wake up signal received by the user equipment may be interrupted. That is, two wake up signals received by the user equipment may correspond to one wake up signal transmitted by the network device. However, due to short interruption time, when the user equipment receives the two adjacent wake up signals at a short interval, the two wake up signals are considered as one wake up signal. On the basis of this, when the two adjacent wake up signals are transmitted by the network device, the time interval between the two wake up signals has to be relatively long, such that the user equipment is prevented from considering the two wake up signals as one wake up signal.

For instance, the set length is 8 microseconds, or 16 microseconds.

In the embodiment, the feature of the wake up signal is determined by the network device on the basis of the user equipment group to which the user equipment to receive the wake up signal belongs, and the wake up signal having the feature is transmitted to the user equipment. The feature of the wake up signal is detected by the user equipment, such that the user equipment group corresponding to the wake up signal is determined. Further, whether the user equipment group is a user equipment group to which the user equipment belongs is determined. Through the method, a waste of energy of the user equipment caused by false alarm can be prevented.

An example of the disclosure provides an apparatus for determining a user equipment group corresponding to a wake up signal. The apparatus is arranged on user equipment. With reference to FIG. 8, the apparatus includes:
a transceiving module 801 configured to receive the wake up signal from a network device; and
a processing module 802 configured to determine the user equipment group corresponding to the wake up signal on the basis of a feature of the wake up signal.

The feature of the wake up signal includes at least one of amplitude, power, duration, and energy.

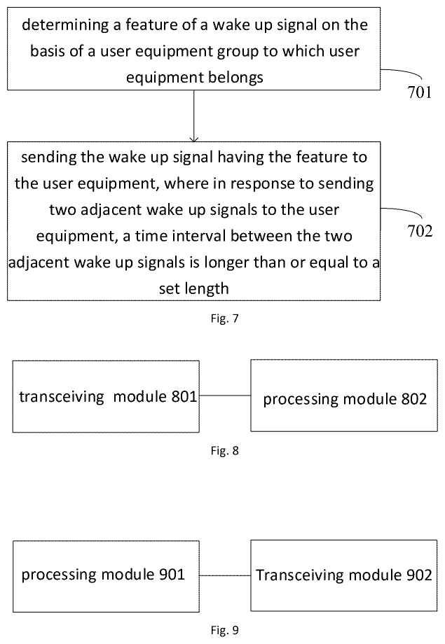

An example of the disclosure provides an apparatus for determining a user equipment group corresponding to a wake up signal. The apparatus is arranged on a network device. With reference to FIG. 9, the apparatus includes:
a processing module 901 configured to determine a feature of the wake up signal on the basis of the user equipment group to which user equipment belongs; and
a transceiving module 902 configured to transmit the wake up signal having the feature to the user equipment.

The feature of the wake up signal includes at least one of amplitude, power, duration, and energy.

An example of the disclosure provides a mobile terminal. The mobile terminal includes:
a processor; and
a memory configured to store an instruction executable by the processor.

The processor is configured to execute the executable instruction in the memory, so as to implement steps of the above method for determining a user equipment group corresponding to a wake up signal.

An example of the disclosure provides a network side device. The network side device includes:
a processor; and
a memory configured to store an instruction executable by the processor.

The processor is configured to execute the executable instruction in the memory, so as to implement steps of the above method for determining a user equipment group corresponding to a wake up signal.

An example of the disclosure provides a non-transitory computer-readable storage medium, which stores an executable instruction. When the executable instruction is performed by a processor, steps of the above method for determining a user equipment group corresponding to a wake up signal are implemented.

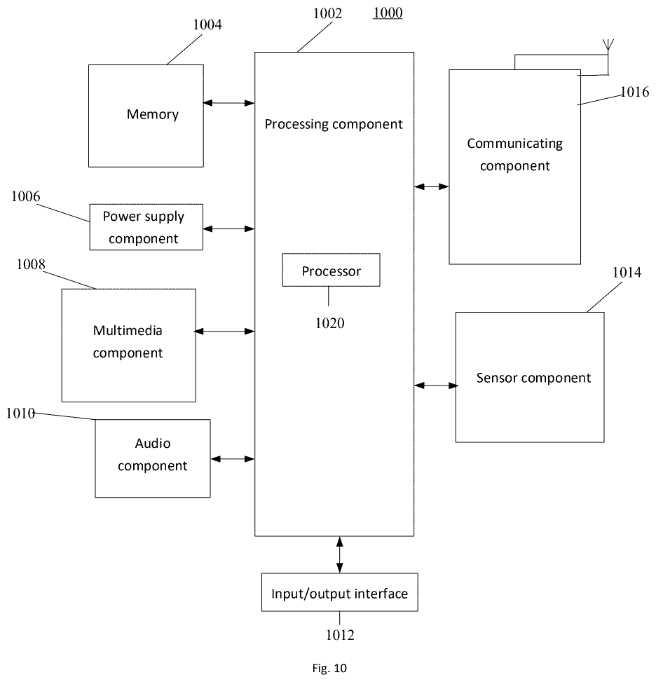

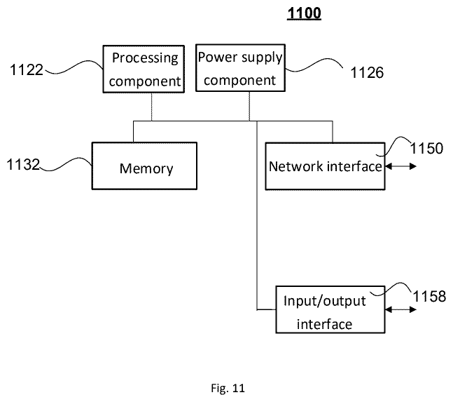

FIG. 10 is a block diagram of an device 1000 for determining a user equipment group corresponding to a wake up signal according to one example. For instance, the device 1000 may be a mobile phone, a computer, a digital broadcast terminal, a messaging device, a game console, a tablet device, a medical device, a fitness device, a personal digital assistant, etc.

With reference to FIG. 10, the device 1000 may include one or more of the following components: a processing component 1002, a memory 1004, a power supply component 1006, a multimedia component 1008, an audio component 1010, an input/output (I/O) interface 1012, a sensor component 1014, and a communicating component 1016.

The processing component 1002 generally controls all operations of the device 1000, such as operations associated with display, telephone call, data communication, camera operation and recording operation. The processing component 1002 may include one or more processors 1020 configured to execute an instruction, so as to complete all or some steps of the method. In addition, the processing component 1002 may include one or more modules to facilitate interaction between the processing component 1002 and other components. For instance, the processing component 1002 may include a multimedia module to facilitate interaction between the multimedia component 1008 and the processing component 1002.

The memory 1004 is configured to store various types of data to support the operations on the device device 1000. Instances of the data include an instruction for any application or method operating on the device 1000, contact data, phone book data, a message, a picture, a video, etc. The memory 1004 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power supply component 1006 supplies power to various components of the device 1000. The power supply component 1006 may include a power management system, one or more power supplies, and other components associated with generating, managing and distributing power for the device 1000.

The multimedia component 1008 includes a screen that provides an output interface between the device 1000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some examples, the multimedia component 1008 includes a front-facing camera and/or a rear-facing camera. When the device 1000 is in an operation mode, such as a photographing mode or a video mode, the front-facing camera and/or the rear-facing camera are/is capable of receiving external multimedia data. Each of the front-facing camera and the rear-facing camera may be a fixed optical lens system or have a focal length and an optical zoom capability.

The audio component 1010 is configured to output and/or input an audio signal. For instance, the audio component 1010 includes a microphone (MIC). The microphone is configured to receive an external audio signal when the device 1000 is in operation modes such as a call mode, a recording mode and a speech identification mode. The received audio signal may be further stored in the memory 1004 or transmitted via the communicating component 1016. In some examples, the audio component 1010 further includes a speaker configured to output an audio signal.

The I/O interface 1012 provides an interface between the processing component 1002 and a peripheral interface module. The peripheral interface module may be a keyboard, a click wheel, a button, etc. The buttons may include, but are not limited to, a home button, a volume button, a start button, and a lock button.

The sensor component 1014 includes one or more sensors for providing various aspects of state assessment for the device 1000. For instance, the sensor component 1014 may detect an on/off state of the device 1000 and relative positioning of the components such as a display and a keypad of the device 1000, and the sensor component 1014 may further detect position change of the device 1000 or a component of the device 1000, presence or absence of contact between the user and the device 1000, an orientation or acceleration/deceleration of the device 1000 and temperature change of the device 1000. The sensor component 1014 may include a proximity sensor configured to detect presence of a nearby object without any physical contact. The sensor component 1014 may further include an optical sensor, such as a complementary metal-oxide-semiconductor (CMOS) or charge-coupled device (CCD) image sensor, which is used in imaging application. In some examples, the sensor component 1014 may further include an acceleration sensor, a gyroscope sensor, a magnetic sensor, a pressure sensor, or a temperature sensor.

The communicating component 1016 is configured to facilitate wired or radio communication between the device 1000 and other devices. The device 1000 may access a radio network based on a communication standard, such as WiFi, the 2nd generation mobile communication technology (2G) or the 3rd generation mobile communication technology (3G), or their combinations. In one example, the communicating component 1016 receives a broadcast signal or broadcast related information from an external broadcast management system via a broadcast channel. In one example, the communicating component 1016 further includes a near field communication (NFC) module to facilitate short-range communication. For instance, the NFC module may be implemented on the basis of a radio frequency identification (RFID) technology, an infrared data association (IrDA) technology, an ultra wide band (UWB) technology, a Bluetooth (BT) technology or other technologies.

In an example, the device 1000 may be implemented by one or more of an application specific integrated circuit (ASIC), a digital signal processor (DSP), a digital signal processing device (DSPD), a programmable logic device (PLD), a field programmable gate array (FPGA), a controller, a micro controller, a microprocessor or other electronic components, thus executing the method.

An example further provides a non-transitory computer-readable storage medium including an instruction, such as the memory 1004 including an instruction. The instruction may be performed by the processor 1020 of the device 1000 so as to complete the method. For instance, the non-transitory computer-readable storage medium may be ROM, a random access memory (RAM), CD-ROM, a magnetic tape, a floppy disk, an optical data storage device, etc.

FIG. 11 is a block diagram of an apparatus 1100 for determining a user equipment group corresponding to a wake up signal according to one example. For instance, the apparatus 1100 may be a base station. With reference to FIG. 11, the apparatus 1100 includes a processing component 1122, which further includes one or more processors, and a memory resource represented by a memory 1132, which is configured to store an instruction executable by the processing component 1122, such as an application. The application stored in the memory 1132 may include one or more modules that each correspond to a group of instructions. In addition, the processing component 1122 is configured to execute the instruction, so as to execute the above method for accessing an unlicensed channel.

The apparatus 1100 may further include a power supply component 1126 configured to execute power management of the apparatus 1100, a wired or radio network interface 1150 configured to connect the apparatus 1100 to a network, and an input/output (I/O) interface 1159. The apparatus 1100 may operate on the basis of an operating system stored in the memory 1132, such as Windows Server™, Mac OS X™, Unix™, Linux™, and FreeBSD™.

Those skilled in the art could easily conceive of other implementation solutions of the examples of the disclosure upon consideration of the description and the invention disclosed here. The disclosure is intended to cover any variations, uses or adaptive changes of the disclosure, which follow the general principles of the disclosure and include common general knowledge or conventional technical means in the technical field not disclosed in the disclosure. The description and the examples are regarded as merely illustrative, and the true scope and spirit of the examples of the disclosure are indicated by the following claims.

It is to be understood that the examples of the disclosure are not limited to a precise structure described above and illustrated in the accompanying drawings, and can have various modifications and changes without departing from the scope. The scope of the examples of the disclosure is limited merely by the appended claims.

### INDUSTRIAL APPLICABILITY

On the basis of a feature of a received wake up signal, a user equipment group corresponding to the wake up signal is determined by user equipment, and further whether the user equipment group is a user equipment group to which the user equipment belongs is determined. In response to determining that the user equipment group is the user equipment group to which the user equipment belongs, whether to receive a paging message or other downlink information, such as downlink data and downlink control information, is determined on the basis of an indication of the wake up signal. Through the method, a waste of energy of the user equipment caused by false alarm can be prevented.

1. A method for determining a user equipment group corresponding to a wake up signal, performed by user equipment, comprising:
receiving the wake up signal from a network device; and
determining the user equipment group corresponding to the wake up signal based on a feature of the wake up signal, wherein
the feature of the wake up signal comprises at least one of amplitude, power, duration, and energy.

2. The method according to claim 1, wherein the amplitude is average amplitude or maximum amplitude.

3. The method according to claim 1, wherein the power is average power or maximum power.

4. The method according to claim 1, wherein the duration is a length of a continuous period in which the amplitude of the wake up signal is greater than a first amplitude threshold.

5. The method according to claim 4, wherein the first amplitude threshold is minimum signal amplitude measurable by a receiver, configured to receive the wake up signal, of the user equipment.

6. The method according to claim 1, wherein the duration is a length of a continuous period in which instantaneous power of the wake up signal is greater than a first power threshold.

7. The method according to claim 6, wherein the first power threshold is minimum signal power measurable by a receiver, configured to receive the wake up signal, of the user equipment.

8. The method according to claim 4, wherein the first amplitude threshold or a first power threshold is agreed by a communication protocol or configured by the network device.

9. The method according to claim 1, further comprising:
determining, in response to determining that a time interval between two adjacent wake up signals is shorter than a set length, that the two adjacent wake up signals are one wake up signal, and duration of the one wake up signal is a mathematical sum of duration of the two wake up signals and the time interval.

10. The method according to claim 1, wherein the energy is a mathematical product of average power of the wake up signal and the duration.

11. The method according to claim 1, further comprising:
receiving configuration information from the network device, wherein the configuration information indicates a plurality of feature values or a plurality of feature value ranges of the feature, and different feature values or different feature value ranges are configured to determine different user equipment groups.

12. The method according to claim 1, further comprising:
obtaining a plurality of feature values or a plurality of feature value ranges of the feature based on a communication protocol, wherein different feature values or different feature value ranges are configured to determine different user equipment groups.

13. The method according to claim 11, wherein the determining the user equipment group corresponding to the wake up signal based on a feature of the wake up signal comprises:
determining the user equipment group corresponding to the wake up signal based on the feature of the wake up signal and the plurality of feature values or the plurality of feature value ranges of the feature.

14. A method for determining a user equipment group corresponding to a wake up signal, performed by a network device, comprising:
determining a feature of the wake up signal based on the user equipment group to which user equipment belongs; and
sending the wake up signal having the feature to the user equipment, wherein
the feature of the wake up signal comprises at least one of amplitude, power, duration, and energy.

15-22. (canceled)

23. The method according to claim 14, further comprising:
sending configuration information to the user equipment, wherein the configuration information indicates a plurality of feature values or a plurality of feature value ranges of the feature, and different feature values or different feature value ranges are configured to determine different user equipment groups.

24. The method according to claim 14, wherein the sending the wake up signal to the user equipment comprises:
sending two adjacent wake up signals to the user equipment, wherein a time interval between the two adjacent wake up signals is longer than or equal to a set length.

25-26. (canceled)

27. A mobile terminal, comprising:
a processor; and
a memory configured to store an instruction executable by the processor, wherein the executable instructions when executed by the processor cause the mobile terminal to:
receive the wake up signal from a network device; and
determine a user equipment group corresponding to the wake up signal based on a feature of the wake up signal, wherein
the feature of the wake up signal comprises at least one of amplitude, power, duration, and energy.

28. A device, comprising:
a processor; and
a memory configured to store processor executable instructions, wherein
the processor executable instruction when executed by the processor cause the device to act as the network device and perform the the method according to claim 14.

29. A non-transitory computer-readable storage medium, storing an executable instruction, wherein when the executable instruction is performed by a processor of the user equipment to perform the method according to claim 1.

30. A non-transitory computer-readable storage medium, storing an executable instruction, wherein when the executable instruction when executed by a processor of a network side device, cause the network side device to perform the method according to claim 14.
